(19) United States
(12) Patent Application Publication
(10) Pub. No.: US 2021/0305834 A1
(43) Pub. Date: Sep. 30, 2021

(54) CONSTANT CURRENT CHARGING DEVICE

(71) Applicant: Silicon Integrated Systems Corp., Hsinchu City (TW)

(72) Inventors: Song-Sheng LIN, Hsinchu City (TW); Keng-Nan CHEN, Hsinchu City (TW)

(21) Appl. No.: 17/205,017

(22) Filed: Mar. 18, 2021

(30) Foreign Application Priority Data
Mar. 27, 2020 (TW) 109110628

(51) Int. Cl. H02J 7/00

(52) U.S. Cl. CPC H02J 7/00712; H02J 2207/20

(57) ABSTRACT

A constant current charging device is configured to charge a device to be charged and includes: a current regulating unit electrically coupled to the device to be charged and configured to provide a regulating current and a charging current according to a reference voltage; a current-to-voltage converting unit electrically coupled to the current regulating unit and configured to output a regulating voltage according to the regulating current; and a first operational amplifier electrically coupled to the current regulating unit, the current-to-voltage converting unit, and the device to be charged and configured to regulate the regulating current.

### TECHNICAL FIELD OF DISCLOSURE

The present disclosure relates to the field of charging technologies, and more particularly to a constant current charging device.

### BACKGROUND OF DISCLOSURE

A conventional charging device includes a constant current charging mode and a constant voltage charging mode. At the beginning of charging a battery, the charging device charges the battery in the constant current charging mode. When the battery is charged to a predetermined voltage, the charging device charges the battery in the constant voltage charging mode.

However, a current and a voltage provided by the conventional charging device are unstable. The unstable current or the unstable voltage not only affects charging efficiency of the battery but also decreases service life of the battery.

Therefore, there is a need to solve the above-mentioned problem in the prior art.

### SUMMARY OF DISCLOSURE

An objective of the present disclosure is to provide a constant current charging device capable of solving the problem in the prior art.

The constant current charging device of the present disclosure includes: a current regulating unit electrically coupled to the device to be charged and configured to provide a regulating current and a charging current according to a reference voltage; a current-to-voltage converting unit electrically coupled to the current regulating unit and configured to output a regulating voltage according to the regulating current; and a first operational amplifier electrically coupled to the current regulating unit, the current-to-voltage converting unit, and the device to be charged and configured to regulate the regulating current.

The constant current charging device of the present disclosure can provide, by the current regulating unit, the current-to-voltage converting unit, and the first operational amplifier, the charging current which has a high current value and is controllable. Furthermore, the constant current charging device of the present disclosure can design the charging current according to channel width/length ratios of transistors of the current regulating unit. Finally, the constant current charging device of the present disclosure can provide, by the current regulating unit, the current-to-voltage converting unit, and the first operational amplifier, the charging current which is stable.

### BRIEF DESCRIPTION OF DRAWINGS

FIG. 1 illustrates a block diagram of a constant current charging device in accordance with an embodiment of the present disclosure.

FIG. 2 illustrates a detailed circuit diagram of the constant current charging device in FIG. 1.

FIG. 3 illustrates a simulation diagram of a charging current I_{C} and a charging voltage V_{C} in FIG. 2.

FIG. 4 illustrates a simulation diagram of a regulating voltage V_{B} and a voltage of a first operational amplifier output O1 in FIG. 2.

FIG. 5 illustrates a block diagram of a constant current charging device in accordance with another embodiment of the present disclosure.

FIG. 6 illustrates a block diagram of a constant current charging device in accordance with yet another embodiment of the present disclosure.

### DETAILED DESCRIPTION OF DISCLOSURE

To make the objectives, technical schemes, and technical effects of the present disclosure more clearly and definitely, the present disclosure will be described in detail below by using embodiments in conjunction with the appending drawings. It should be understood that the specific embodiments described herein are merely for explaining the present disclosure, and as used herein, the term “embodiment” refers to an instance, an example, or an illustration but is not intended to limit the present disclosure. In addition, the articles “a” and “an” as used in the specification and the appended claims should generally be construed to mean “one or more” unless specified otherwise or clear from the context to be directed to a singular form. Also, in the appending drawings, the components having similar or the same structure or function are indicated by the same reference number.

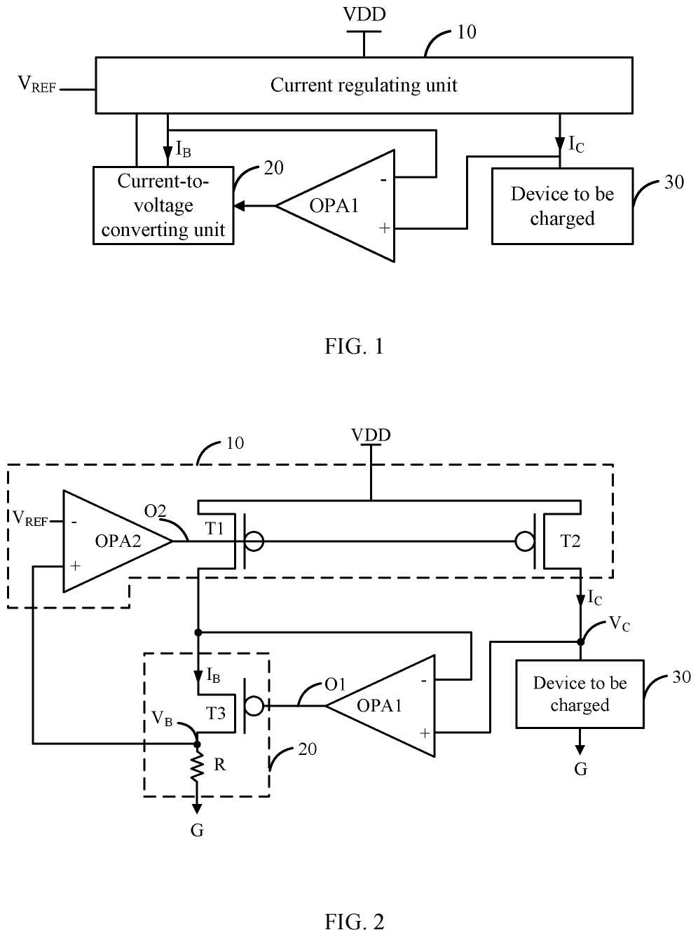

Please refer to FIG. 1 and FIG. 2. FIG. 1 illustrates a block diagram of a constant current charging device in accordance with an embodiment of the present disclosure. FIG. 2 illustrates a detailed circuit diagram of the constant current charging device in FIG. 1.

The constant current charging device is configured to charge a device 30 to be charged and includes a current regulating unit 10, a current-to-voltage converting unit 20, and a first operational amplifier OPAL

The device 30 to be charged of the present disclosure may be but not limited to a circuit required to be charged or a rechargeable battery.

The current regulating unit 10 is electrically coupled to a power source VDD and the device 30 to be charged and configured to provide a regulating current I_{B} and a charging current I_{C} according to a reference voltage V_{REF}. The charging current I_{C} is configured to charge the device 30 to be charged, and the charging current I_{C} can be M times of the regulating current I_{B}. M is a positive integer. In detail, the current regulating unit 10 can control to increase or decrease the charging current I_{C}. Furthermore, the current regulating unit 10 is further configured to adjust a charging voltage V_{C} of the device 30 to be charged. In detail, the current regulating unit 10 can control to increase or decrease the charging voltage V_{C}. The power source VDD may be a direct-current power source. The reference voltage V_{REF} can be adjusted according to requirements.

The current-to-voltage converting unit 20 is electrically coupled to the current regulating unit 10 and configured to output a regulating voltage V_{B} according to the regulating current I_{B}.

The first operational amplifier OPA1 is electrically coupled to the current regulating unit 10, the current-to-voltage converting unit 20, and the device 30 to be charged and configured to regulate the regulating current I_{B} according to the charging voltage V_{C} inputted to the device 30 to be charged. The first operational amplifier OPA1 includes an inverting input −, a non-inverting input +, and a first operational amplifier output O1. The inverting input − of the first operational amplifier OPA1 is electrically coupled to the current regulating unit 10 and the current-to-voltage converting unit 20. The non-inverting input + of the first operational amplifier OPA1 is electrically coupled to the current regulating unit 10 and the device 30 to be charged. The first operational amplifier output O1 of the first operational amplifier OPA1 is electrically coupled to the current-to-voltage converting unit 20.

As shown in FIG. 2, the current regulating unit 10 includes a first transistor T1, a second transistor T2, and a second operational amplifier OPA2.

The first transistor T1 includes a first control terminal, a first input terminal, and a first output terminal. The second transistor T2 includes a second control terminal, a second input terminal, and a second output terminal. The second operational amplifier OPA2 includes an inverting input −, a non-inverting input +, and a second operational amplifier output O2.

The first control terminal is electrically coupled to the second control terminal. The first input terminal is electrically coupled to the power source VDD. The first output terminal is electrically coupled to the current-to-voltage converting unit 20 and the first operational amplifier OPAL The second input terminal is electrically coupled to the power source VDD. The second output terminal is electrically coupled to the first operational amplifier OPA1 and the device 30 to be charged. The inverting input − of the second operational amplifier OPA2 is electrically coupled to the reference voltage V_{REF}. The non-inverting input + of the second operational amplifier OPA2 is electrically coupled to the regulating voltage V_{B}. The second operational amplifier output O2 of the second operational amplifier OPA2 is electrically coupled to the first control terminal and the control second terminal.

In the present embodiment, the first transistor T1 and the second transistor T2 may be P-type Metal-Oxide-Semiconductor Field-Effect Transistor (PMOSFET).

The current-to-voltage converting unit 20 includes a third transistor T3 and a resistor R. The third transistor includes a third control terminal, a third input terminal, and a third output terminal. The third control terminal is electrically connected to the first operational amplifier output O1 of the first operational amplifier OPAL The third input terminal is electrically connected to the inverting input − of the first operational amplifier OPAL One terminal of the resistor R is electrically connected to the third output terminal. The other terminal of the resistor R is electrically connected to the ground G.

In the present embodiment, the third transistor T3 may be a PMOSFET.

An operating principle of the constant current charging device of the present disclosure will be described in detail as follows.

First, the regulating voltage V_{B} is zero in an initial state. A voltage (equal to zero) of the non-inverting input + of the second operational amplifier OPA2 is smaller than the reference voltage V_{REF}. The second operational amplifier OPA2 outputs a low voltage level. The charging voltage V_{C} is zero in an initial state. Accordingly, a voltage inputted to the inverting input − of the first operational amplifier OPA1 is greater than the charging voltage V_{C}. The first operational amplifier OPA1 outputs a low voltage level. The first transistor T1 and the third transistor T3 are turned on, and the regulating current I_{B} is generated.

The charging current I_{C} can be M times of the regulating current I_{B}. In detail, the charging current I_{C} relates to a channel width/length ratio (W1/L1) of the first transistor T1 and a channel width/length ratio (W2/L2) of the second transistor T2. M is a ratio of the channel width/length ratio (W1/L1) of the first transistor T1 to the channel width/length ratio (W2/L2) of the second transistor T2. W1 is a channel width of the first transistor T1, and L1 is a channel length of the first transistor T1. W2 is a channel width of the second transistor T2, and L2 is a channel length of the second transistor T2. A relationship between the charging current I_{C} and the regulating current I_{B}:

I_{C}=M×I_{B}=M×I_{B}=(W1/L1)/(W2/L2)×I_{B}.

When the charging current I_{C} is raised and the charging voltage V_{C} is greater than the voltage inputted to the inverting input − of the first operational amplifier OPA1, the first operational amplifier OPA1 outputs a high voltage level to decrease the regulating current I_{B}. When the regulating voltage V_{B} is close to the reference voltage V_{REF}, the second operational amplifier OPA2 outputs a high voltage level to decrease the charging current I_{C}. When the regulating voltage V_{B} is raised to the reference voltage V_{REF}, the second transistor T2 stops providing the charging current I_{C}. That is, when the regulating voltage V_{B} is equal to the reference voltage V_{REF}, the charging current I_{C} is zero.

In summary, the constant current charging device of the present disclosure can control to increase or decrease the charging current I_{C} and control to increase or decrease the charging voltage V_{C} by the current regulating unit 10, the current-to-voltage converting unit 20, and the first operational amplifier OPA1, thereby providing the charging current I_{C} and the charging voltage V_{C} which are stable. Furthermore, the constant current charging device of the present disclosure can provide, by the current regulating unit 10, the charging current I_{C} which has a high current value and is controllable.

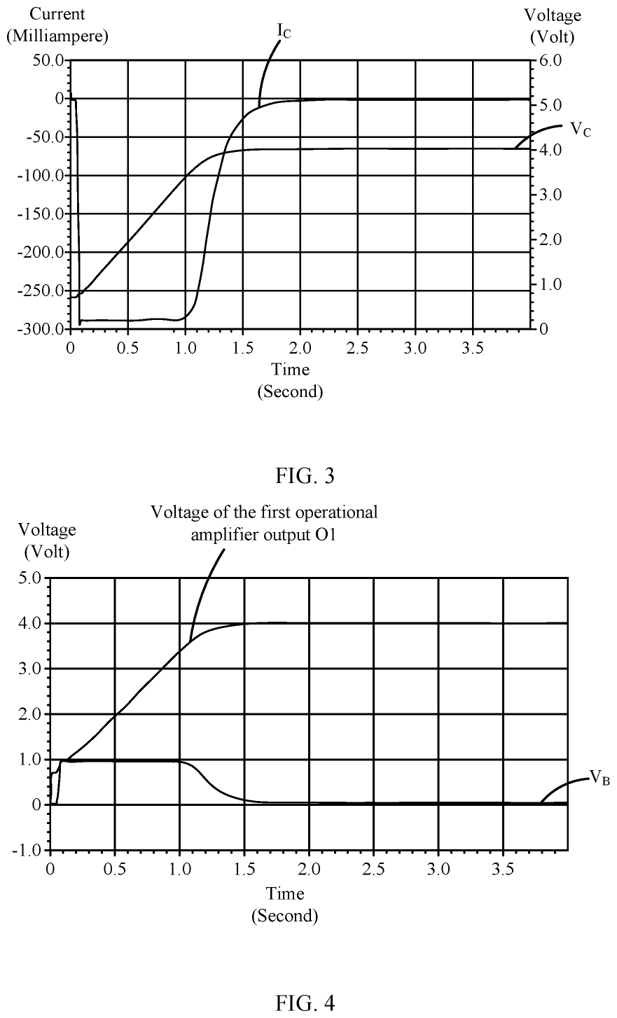

Please refer to FIG. 3. FIG. 3 illustrates a simulation diagram of the charging current I_{C} and the charging voltage V_{C} in FIG. 2.

In the simulation diagram of FIG. 3, the power source VDD is 4 volts, the reference voltage V_{REF} is 1 volt, the reference current I_{RFF} is 100 microamperes, the charging current I_{C} is 200 milliamperes, and the device 30 to be charged is a one farad capacitor.

It can be understood from FIG. 3 that the charging current I_{C} can rapidly provide a stable current of 200 milliamperes at about 2 seconds. When the charging voltage V_{C} is raised gradually, the charging current I_{C} is decreased gradually. When the charging voltage V_{C} is raised to the power source VDD (4 volts), the charging current I_{C} is decreased to zero.

It is noted that the charging current I_{C} shown in negative values represents a definition of a current direction.

Please refer to FIG. 4. FIG. 4 illustrates a simulation diagram of the regulating voltage V_{B} and a voltage of the first operational amplifier output O1 in FIG. 2.

It can be understood from FIG. 4 that the voltage of the first operational amplifier output O1 is raised to the power source VDD (4 volts) gradually, the regulating voltage V_{B} is decreased to 0 volts gradually.

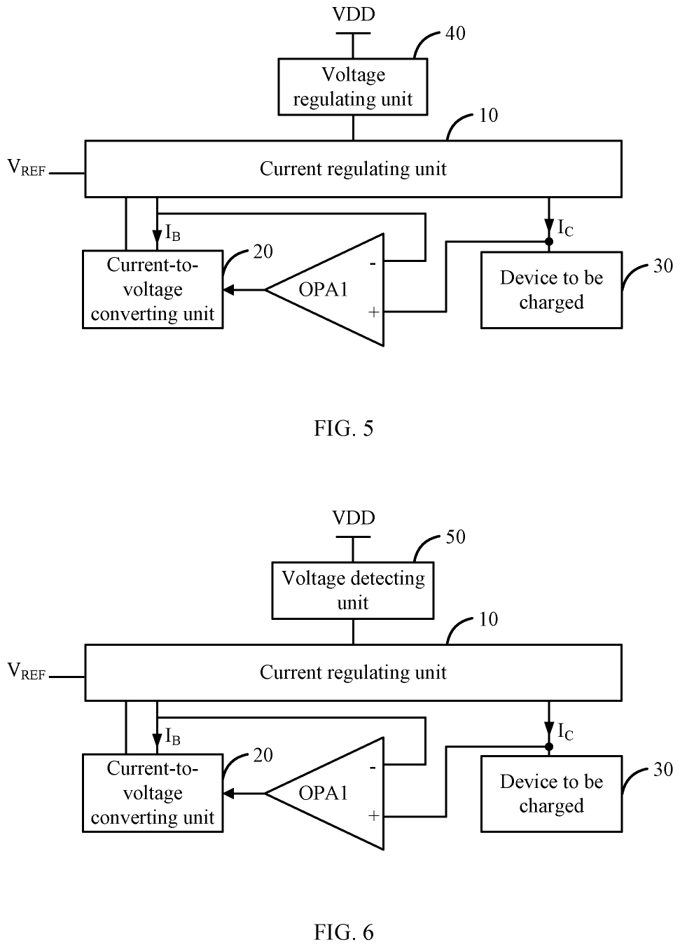

Please refer to FIG. 5. FIG. 5 illustrates a block diagram of a constant current charging device in accordance with another embodiment of the present disclosure.

A difference between the constant current charging device in FIG. 5 and the constant current charging device in FIG. 1 is that the constant current charging device in FIG. 5 further includes a voltage regulating unit 40. The voltage regulating unit 40 is electrically coupled between the power source VDD and the current regulating unit 10 and configured to adjust the charging voltage V_{C}. In detail, the voltage regulating unit 40 can control the charging voltage V_{C} of the device 30 to be charged to any one voltage excluding the power source VDD. The voltage regulating unit 40 may be but not limited to a low-dropout (LDO) regulator or a booster.

Please refer to FIG. 6. FIG. 6 illustrates a block diagram of a constant current charging device in accordance with yet another embodiment of the present disclosure.

A difference between the constant current charging device in FIG. 6 and the constant current charging device in FIG. 1 is that the constant current charging device in FIG. 6 further includes a voltage detecting unit 50. The voltage detecting unit 50 is electrically coupled between the power source VDD and the current regulating unit 10 and configured to adjust the charging voltage V_{C}. In detail, the voltage detecting unit 50 can control the charging voltage V_{C} of the device 30 to be charged to any one voltage excluding the power source VDD. The voltage detecting unit 50 may be but not limited to a comparator.

The constant current charging device of the present disclosure can provide, by the current regulating unit, the current-to-voltage converting unit, and the first operational amplifier, the charging current (as shown in FIG. 3) which has a high current value and is controllable. Furthermore, the constant current charging device of the present disclosure can design the charging current according to the channel width/length ratios of the transistors of the current regulating unit. Finally, the constant current charging device of the present disclosure can provide, by the current regulating unit, the current-to-voltage converting unit, and the first operational amplifier, the charging current (as show in FIG. 3) which is stable.

While the preferred embodiments of the present disclosure have been illustrated and described in detail, various modifications and alterations can be made by persons skilled in this art. The embodiment of the present disclosure is therefore described in an illustrative but not restrictive sense. It is intended that the present disclosure should not be limited to the particular forms as illustrated, and that all modifications and alterations which maintain the spirit and realm of the present disclosure are within the scope as defined in the appended claims.

What is claimed is:

1. A constant current charging device, configured to charge a device to be charged, and the constant current charging device comprising:
a current regulating unit electrically coupled to the device to be charged and configured to provide a regulating current and a charging current according to a reference voltage;
a current-to-voltage converting unit electrically coupled to the current regulating unit and configured to output a regulating voltage according to the regulating current; and
a first operational amplifier electrically coupled to the current regulating unit, the current-to-voltage converting unit, and the device to be charged and configured to regulate the regulating current.

2. The constant current charging device according to claim 1, wherein the charging current is M times of the regulating current, and M is a positive integer.

3. The constant current charging device according to claim 2, wherein the first operational amplifier comprises:
an inverting input electrically coupled to the current regulating unit and the current-to-voltage converting unit;
a non-inverting input electrically coupled to the current regulating unit and the device to be charged; and
a first operational amplifier output electrically coupled to the current-to-voltage converting unit.

4. The constant current charging device according to claim 3, wherein the current regulating unit comprises:
a first transistor comprising a first control terminal, a first input terminal, and a first output terminal; and
a second transistor comprising a second control terminal, a second input terminal, and a second output terminal; and
a second operational amplifier comprising an inverting input, a non-inverting input, and a second operational amplifier output;
wherein the first control terminal is electrically coupled to the second control terminal, the first input terminal is electrically coupled to a power source, the first output terminal is electrically coupled to the current-to-voltage converting unit and the first operational amplifier, the second input terminal is electrically coupled to the power source, the second output terminal is electrically coupled to the first operational amplifier and the device to be charged, the inverting input of the second operational amplifier is electrically coupled to the reference voltage, the non-inverting input of the second operational amplifier is electrically coupled to the regulating voltage, and the second operational amplifier output of the second operational amplifier is electrically coupled to the first control terminal and the control second terminal.

5. The constant current charging device according to claim 4, wherein the current-to-voltage converting unit comprises:
a third transistor comprising a third control terminal, a third input terminal, and a third output terminal; and
a resistor;
wherein the third control terminal is electrically connected to the first operational amplifier output of the first operational amplifier, the third input terminal is electrically connected to the inverting input of the first operational amplifier, one terminal of the resistor is electrically connected to the third output terminal, and the other terminal of the resistor is electrically connected to the ground.

6. The constant current charging device according to claim 4, wherein M is a ratio of a channel width/length ratio of the first transistor to a channel width/length ratio of the second transistor.

7. The constant current charging device according to claim 1, wherein the current regulating unit is further configured to adjust a charging voltage of the device to be charged, and the first operational amplifier is further configured to regulate the regulating current according to the charging voltage.

8. The constant current charging device according to claim 7, further comprising a voltage regulating unit, wherein the voltage regulating unit is electrically coupled between a power source and the current regulating unit and configured to adjust the charging voltage.

9. The constant current charging device according to claim 7, further comprising a voltage detecting unit, wherein the voltage detecting unit is electrically coupled between a power source and the current regulating unit and configured to adjust the charging voltage.

10. The constant current charging device according to claim 1, wherein when the regulating voltage is equal to the reference voltage, the charging current is zero.
